(19) United States
(12) Patent Application Publication
(10) Pub. No.: US 2025/0165920 A1
(43) Pub. Date: May 22, 2025

(54) SYSTEMS AND METHODS FOR ADDRESSING CROSS-PEGGING IN A MULTI-LEVEL SEARCH

(71) Applicant: KINAXIS INC., Ottawa (CA)

(72) Inventors: Chao ZHAO, Ottawa (CA); Vsevolod SKORTSOV, Richmond Hill (CA); Carsten S. JORDAN, San Diego, CA (US)

(73) Assignee: KINAXIS INC., Ottawa (CA)

(21) Appl. No.: 18/955,416

(22) Filed: Nov. 21, 2024

Related U.S. Application Data
(60) Provisional application No. 63/602,211, filed on Nov. 22, 2023.

(51) Int. Cl. G06Q 10/087

(52) U.S. Cl. CPC G06Q 10/087

(57) ABSTRACT

Methods and systems for elimination of cross-pegging, comprising: consumption of input supplies by a new demand; marking a supply exchange based on a first-pass supply exchange and a cascading supply exchange; creating planned orders; running one or more trials; and executing the supply exchange.

The present application claims the benefit of U.S. Provisional Patent Application No. 63/602,211 filed Nov. 22, 2024, which is incorporated entirely herein by reference.

### BACKGROUND

A Multi-Level-Search (MLS) algorithm can be used for supply chain planning. MLS tries to process a single demand before moving on to another demand. The processing order of these demands is therefore important to achieve good solution quality and fairness. In general, chronological date sequence is a favorable sorting criterion. However, MLS may violate chronological date sequence for two reasons. The first reason is order priority: high-priority demands must be satisfied before low-priority demands-if priority is honored. The second reason is that even if the driving demands are processed in date sequence, the dependent demands on a component part may be out of date sequence because cumulative lead times may be different. This violation of date sequence is a root cause for many limitations of an MLS algorithm, including the cross pegging of input supplies and short term excess.

The term cross-pegging can be interpreted in the following way: an earlier supply is used by a later demand, and a later supply is used by an earlier demand. The two pegging lines cross with each other and hence the name. In practice, there could be many supplies and demands, and some may have this issue and some may not. The issue is caused by not sequencing demands based on their dates. If a demand with a later due date is processed first, the demand may consume an input supply that is due much earlier if the supply is the only available on-time input supply. When another demand with an earlier due date is processed, it cannot use the input supply anymore and therefore creates a new planned order for itself. This would create a situation when supplies are cross pegged to demands.

Cross pegging can cause a new planned order to be generated earlier than necessary, leading to three significant consequences. First, a prebuilt planned order creates some short-term excess that must be stored somewhere. That is, unnecessary inventory is built up, which requires physically storage and all of the physical amenities required to maintain that inventory. Elimination (or even reduction) of cross-pegging thus reduces the physical space required for inventory.

A second disadvantage is that because planned orders are generated earlier than necessary, part sources that have a long lead time might not be usable. For example, an order must be shipped by air when it could have been shipped by boat. This has a tremendous impact on the environment as the carbon footprint of shipment by air is much larger than that shipped by boat. Elimination (or even reduction) of cross-pegging thus has implications on reducing negative environmental impact by changing the mode of shipping to a mode that reduces the adverse effects on the environment.

A third issue is that since we are running the trial on the earlier date, we consume input supplies and constraints on lower level components earlier than necessary. When material availability is limited and/or constraints are overloaded, MLS might not be able to satisfy later processed demands on time when those demands could have been satisfied in an optimal solution.

The first problem can be solved by a post-processing algorithm called MLS smoothing algorithm which pushes the planned orders to later dates. However, MLS smoothing cannot change source selection: part source decisions are made in the MLS trials and no post-processing can remedy a wrong part source decision. MLS smoothing also cannot improve solution quality: trial available dates/quantities have been determined by the time MLS smoothing runs.

### BRIEF SUMMARY

Systems and methods disclosed herein can solve the cross pegging issue of the MLS algorithm. If MLS needs to create a new planned order for a demand, the planned order would be on the same date as the demand. However, supply exchange would create the new planned order on a date later than the demand date. The new demand will exchange supplies with previous demands: the new demand can use supplies that were used by previous demands, and those previous demands would use the newly created planned order instead. With supply exchange, planned orders are created on dates when they are really needed. This prevents short term excess, and allows for correct sourcing decisions.

In one aspect, there is provided a computing apparatus that includes a processor. The computing apparatus also includes a memory storing instructions that, when executed by the processor, configure the apparatus to: process, by the processor, a new demand; consume, by the processor, one or more input supplies; mark, by the processor, a supply exchange; create, by the processor, one or more planned orders; execute, by the processor, one or more trials; and execute, by the processor, the supply exchange.

When marking the supply exchange, the apparatus can be further configured to: execute, by the processor, a first-pass supply exchange; execute, by the processor, a cascading supply exchange; and consume, by the processor, the one or more input supplies.

When executing of the supply exchange, the apparatus can be further configured to: execute, by the processor, consumption of input supplies and/or planned orders by one or more previous demand; execute, by the processor, consumption of remaining input supplies and/or planned orders by one or more new demands; and update, by the processor, a cross-pegging tracker. Other technical features may be readily apparent to one skilled in the art from the following figures, descriptions, and claims.

In one aspect, there is provided a non-transitory computer-readable storage medium, the computer-readable storage medium including instructions that when executed by a computer, cause the computer to: process, by the processor, a new demand; consume, by the processor, one or more input supplies; mark, by the processor, a supply exchange; create, by the processor, one or more planned orders; execute, by the processor, one or more trials; and execute, by the processor, the supply exchange.

When marking of the supply exchange, the computer can be further configured to: execute, by the processor, a first-pass supply exchange; execute, by the processor, a cascading supply exchange; and consume, by the processor, the one or more input supplies.

When executing of the supply exchange, the computer can be further configured to: execute, by the processor, consumption of input supplies and/or planned orders by one or more previous demand; execute, by the processor, consumption of remaining input supplies and/or planned orders by one or more new demands; and update, by the processor, a cross-pegging tracker. Other technical features may be readily apparent to one skilled in the art from the following figures, descriptions, and claims.

In one aspect, there is provided a computer-implemented method that includes: processing, by a processor, a new demand; consuming, by the processor, one or more input supplies; marking, by the processor, a supply exchange; creating, by the processor, one or more planned orders; executing, by the processor, one or more trials; and executing, by the processor, the supply exchange.

When marking of the supply exchange, the computer-implemented method may further comprise: executing, by the processor, a first-pass supply exchange; executing, by the processor, a cascading supply exchange; and consuming, by the processor, the one or more input supplies.

When executing the supply exchange, the computer-implemented method may further comprise: executing, by the processor, consumption of input supplies and/or planned orders by one or more previous demands; executing, by the processor, consumption of remaining input supplies and/or planned orders by one or more new demands; and updating, by the processor, a cross-pegging tracker. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for addressing cross-pegging in a Multi-Level Search in accordance with one embodiment.

FIG. 2 illustrates a block diagram in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

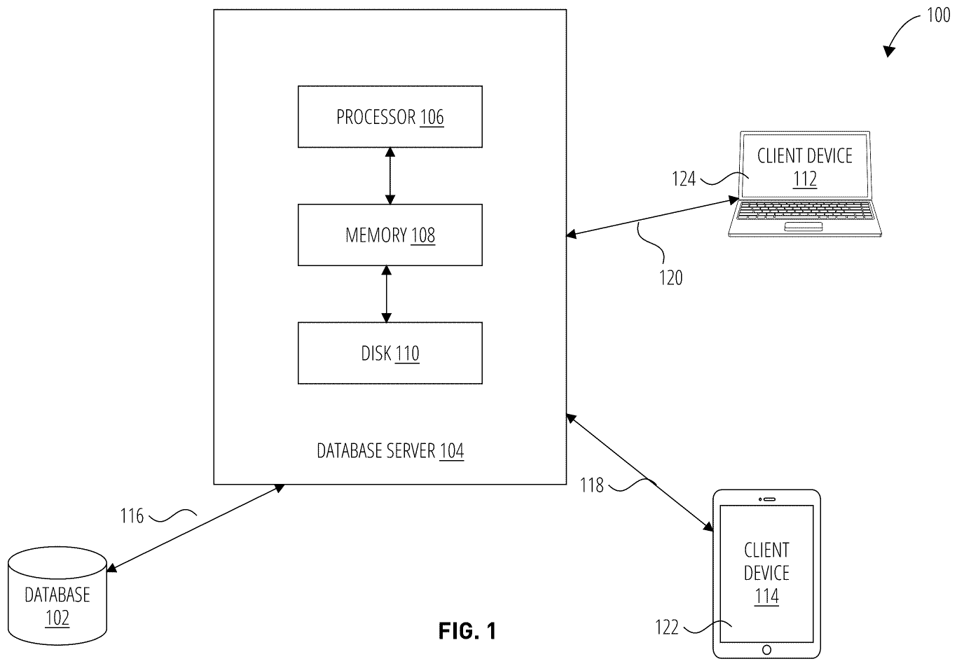

FIG. 1 illustrates an example of a system 100 for addressing cross-pegging in a Multi-Level Search.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

Systems and methods for Multi-Level Search supply cross-pegging may comprise the following elements: maintenance of data of all cross-pegging instances; postponement of the creation of planned orders; determination of how much to postpone due dates of new planned orders based on cross-pegging data; first-pass exchange; cascading exchange; creation of new planned orders on postponed dates; and exchange of supplies between previous demands and new demands.

The algorithm maintains data that track instances of supply cross pegging. As long as a demand uses a supply and this supply is available earlier than the demand, the supply-demand allotment is injected into the data set.

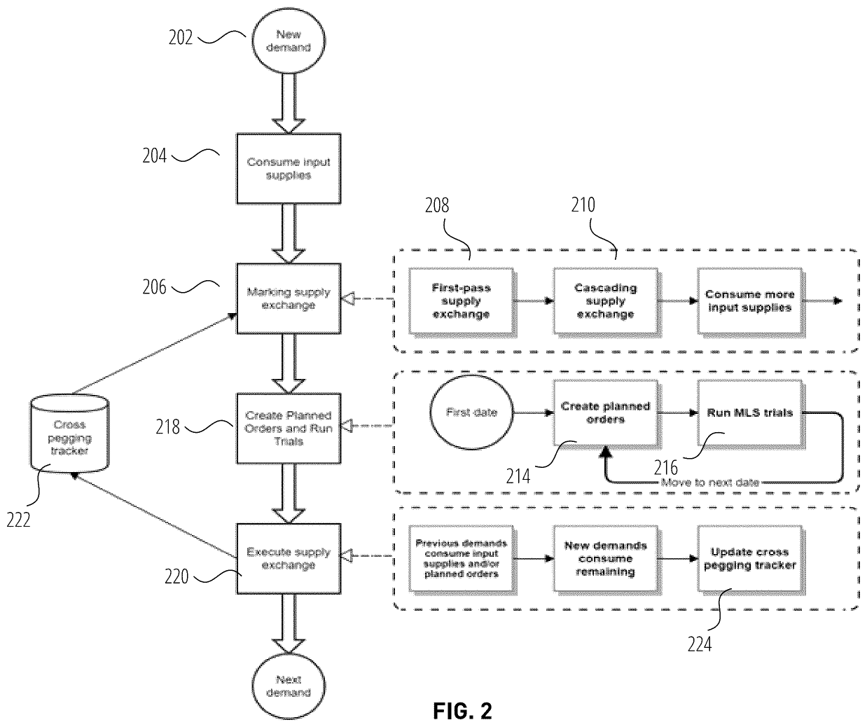

FIG. 2 illustrates a block diagram in accordance with one embodiment.

When MLS processes a new demand at 202, it consumes input supplies at 204 and examines the data and looks for opportunities to exchange supplies. If an old demand has a later due date than the new demand, and the old demand was using a supply that is on time for the new demand, the supply can be exchanged at 206. This step of supply exchange happens in multiple passes: in the first pass (208), the new demand attempts to exchange supplies with older demands; in the cascading pass (210), those older demands that participated in the first-pass then attempt to find more exchange opportunities. Each supply exchange can postpone creation of new planned orders further. It is possible to postpone to multiple dates and the full quantity may be split among these dates. Supply exchanges are not firmed up in this step.

After determining postponed dates and quantities, MLS can create planned orders (at 214) accordingly on those dates. It is possible that after MLS runs trials (at 216), it is found that these planned orders are not available on their due dates. Proceeding with supply exchange will thus cause extra lateness of previous demands, and therefore the supply exchange will be reverted. This is the main reason why supply exchanges are not firmed up in the previous step.

Once the new planned orders are created and their availability dates/quantities are calculated (at 218), MLS can reallot the supplies (including the exchanged supplies and the new planned orders) among the demands that participated in the supply exchange. An observed rule is that previous demands cannot get any new late supplies. The supply exchange is then executed at 220 and the cross pegging tracker 222 is updated at 224.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
process, by the processor, a new demand;
consume, by the processor, one or more input supplies;
mark, by the processor, a supply exchange;
create, by the processor, one or more planned orders;
execute, by the processor, one or more trials; and
execute, by the processor, the supply exchange.

2. The computing apparatus of claim 1, wherein when marking the supply exchange, the apparatus is further configured to:
execute, by the processor, a first-pass supply exchange;
execute, by the processor, a cascading supply exchange; and
consume, by the processor, the one or more input supplies.

3. The computing apparatus of claim 1, wherein executing of the supply exchange, the apparatus is further configured to:
execute, by the processor, consumption of input supplies and/or planned orders by one or more previous demands;
execute, by the processor, consumption of remaining input supplies and/or planned orders by one or more new demands; and
update, by the processor, a cross-pegging tracker.

4. A non-transitory computer-readable storage medium, the computer-readable storage medium including instructions that when executed by a computer, cause the computer to:
process, by a processor, a new demand;
consume, by the processor, one or more input supplies;
mark, by the processor, a supply exchange;
create, by the processor, one or more planned orders;
execute, by the processor, one or more trials; and
execute, by the processor, the supply exchange.

5. The computer-readable storage medium of claim 4, wherein when marking of the supply exchange, the computer is further configured to:
execute, by the processor, a first-pass supply exchange;
execute, by the processor, a cascading supply exchange; and
consume, by the processor, the one or more input supplies.

6. The computer-readable storage medium of claim 4, wherein when executing of the supply exchange, the computer is further configured to:
execute, by the processor, consumption of input supplies and/or planned orders by one or more previous demands;
execute, by the processor, consumption of remaining input supplies and/or planned orders by one or more new demands; and
update, by the processor, a cross-pegging tracker.

7. A computer-implemented method comprising:
processing, by a processor, a new demand;
consuming, by the processor, one or more input supplies;
marking, by the processor, a supply exchange;
creating, by the processor, one or more planned orders;
executing, by the processor, one or more trials; and
executing, by the processor, the supply exchange.

8. The computer-implemented method of claim 7, wherein the marking of the supply exchange comprises:
executing, by the processor, a first-pass supply exchange;
executing, by the processor, a cascading supply exchange; and
consuming, by the processor, the one or more input supplies.

9. The computer-implemented method of claim 7, wherein the executing of the supply exchange comprises:
executing, by the processor, consumption of input supplies and/or planned orders by one or more previous demands;
executing, by the processor, consumption of remaining input supplies and/or planned orders by one or more new demands; and
updating, by the processor, a cross-pegging tracker.
